(19) United States
(12) Patent Application Publication
(10) Pub. No.: US 2013/0251887 A1
(43) Pub. Date: Sep. 26, 2013

(54) NANO-PATTERNING APPARATUS, SYSTEM HAVING THE SAME, AND CONTROL METHOD THEREOF

(71) Applicants: Seon Young Myoung, Gyunggi-do (KR); Young Ju Lee, Gyunggi-do (KR); Yun Bog Kim, Gyunggi-do (KR); Suk Jin Ham, Gyunggi-do (KR); Seong Chan Park, Gyunggi-do (KR); Hyun Jung Lee, Gyunggi-do (KR)

(72) Inventors: Seon Young Myoung, Gyunggi-do (KR); Young Ju Lee, Gyunggi-do (KR); Yun Bog Kim, Gyunggi-do (KR); Suk Jin Ham, Gyunggi-do (KR); Seong Chan Park, Gyunggi-do (KR); Hyun Jung Lee, Gyunggi-do (KR)

(73) Assignee: SAMSUNG ELECTRO-MECHANICS CO., LTD., Gyunggi-do (KR)

(21) Appl. No.: 13/483,606

(22) Filed: May 30, 2012

(30) Foreign Application Priority Data
Mar. 21, 2012 (KR) 1020120028893

(51) Int. Cl. B05C 5/02; B05D 1/26

(52) U.S. Cl. 427/8; 118/300

(57) ABSTRACT

Disclosed herein is a nano-patterning system including a nano-patterning apparatus. The nano-patterning apparatus includes: a holder unit including a transfer unit and an insulating unit; a tip unit inserted into the holder unit, downwardly protruded, and having a flow channel; a flow path having one end connected to the flow channel through one side of the transfer unit or the insulating unit and extending to the outside to serve as a movement path allowing a nano-patterning material to move therealong; a pressing unit pressing the nano-patterning material at one side of the flow path; and a storage unit connected to the other end of the flow path and storing the nano-patterning material.

### CROSS REFERENCE TO RELATED APPLICATION

This application claims the benefit of Korean Patent Application No. 10-2012-0028893, filed on Mar. 21, 2012, entitled “Nano-Patterning Apparatus, System Having the Same and Control Method Thereof”, which is hereby incorporated by reference in its entirety into this application.

### BACKGROUND OF THE INVENTION

1. Technical Field

The present invention relates to a nano-patterning apparatus, a nano-patterning system having the same, and a control method thereof.

2. Description of the Related Art

A lithography technology is a core technology of a nano-patterning process. The lithography technology, by which a thin film is coated on a surface of metal and etched to have a desired shape through chemical processes, has reached the level of processing to obtain precision of 10 nm scale.

However, the lithography technique includes a plurality of processes, having disadvantages in that it is complicated and incurs high processing costs.

Namely, in order to form a single pattern according to a typical lithography technique, first, a mask is fabricated, photoresist is applied to an upper surface of a layer on which a pattern is to be formed, and hardened.

Thereafter, ultraviolet rays are irradiated to the hardened photoresist layer through a mask to change the characteristics (or form and quality) of the photoresist, and finally, an unnecessary portion is removed through chemical etching. Namely, the plurality of processes is complicated.

Thus, in order to reduce such ineffectiveness, researchers have focused toward a technology that allows for printing of nano-scale printing easily and simply like handwriting on paper with a pen.

Korean Patent Laid-Open Publication No. 2010-0043542 (laid-open published on Apr. 29, 2010) is one of the conventional nano-patterning technologies that meet the requirements. This document discloses a method using a dip-pen and an ink-jet method, but these methods are not appropriate for forming a pattern having a uniform size like solder balls.

Namely, with the method using a dip-pen, patterning is performed by supplying ink to a tip, so it is impossible to continuously perform a process, having a problem with mass-production, and the ink-jet method allows for nano-level patterning but has a disadvantage in that it takes a long time.

### SUMMARY OF THE INVENTION

The present invention has been made in an effort to provide a nano-patterning apparatus capable of continuously performing a patterning process for a short time.

The present invention has also been made in an effort to provide a nano-patterning system including a nano-patterning apparatus capable of continuously performing a patterning process for a short time.

The present invention has also been made in an effort to provide a nano-patterning control method capable of continuously performing a patterning process.

According to a first preferred embodiment of the present invention, there is provided a nano-patterning apparatus including: a holder unit including a transfer unit and an insulating unit; a tip unit inserted into the holder unit, downwardly protruded, and having a flow channel; a flow path having one end connected to the flow channel through one side of the transfer unit or the insulating unit and extending to the outside to serve as a movement path allowing a nano-patterning material to move therealong; a pressing unit pressing the nano-patterning material at one side of the flow path; and a storage unit connected to the other end of the flow path and storing the nano-patterning material.

The tip unit may include at least two tips, and the flow channel may be formed between the two tips.

The tip may be formed such that a middle portion thereof is hollow and may have a wedge shape gradually sharpened in a protruded direction.

The tip may include an insulator formed therein and a high resistance metal film covering the insulator, and generate heat when a current is applied through the high resistance metal film.

The transfer unit may include a piezo-actuator or a motor.

The nano-patterning material may include solder paste or conductive paste.

According to a second preferred embodiment of the present invention, there is provided a nano-patterning system including: a stage allowing a subject, on which a pattern is to be formed through nano-patterning, to be mounted thereon; a nano-patterning apparatus performing nano-patterning on the subject mounted on the stage; a controller connected to the stage and the nano-patterning apparatus to control a nano-patterning process; and a display unit connected to the controller to display control information during the nano-patterning process.

The nano-patterning apparatus may include: a holder unit including a transfer unit and an insulating unit; a tip unit inserted into the holder unit, downwardly protruded, and having a flow channel; a flow path having one end connected to the flow channel through one side of the transfer unit or the insulating unit and extending to the outside to serve as a movement path allowing a nano-patterning material to move therealong; a pressing unit pressing the nano-patterning material at one side of the flow path; and a storage unit connected to the other end of the flow path and storing the nano-patterning material.

The tip unit may include at least two tips, and the flow channel may be formed between the two tips. The tip may be formed such that a middle portion thereof is hollow and may have a wedge shape gradually sharpened in a protruded direction.

The tip may include an insulator formed therein and a high resistance metal film covering the insulator, and generate heat when a current is applied to the high resistance metal film by the controller.

The transfer unit may include a piezo-actuator or a motor and may be connected to the controller so as to be position-controlled in X-Y-Z axes directions.

According to a third preferred embodiment of the present invention, there is provided a method of controlling nano-patterning, including: performing pre-heating on a region of a subject, on which a nano-pattern is to be formed, by using a nano-patterning apparatus; discharging a nano-patterning material to the region of the pre-heated subject by using the nano-patterning apparatus; determining whether or not the nano-patterning material has been discharged to be implemented according to pre-set information; and when the nano-patterning material has been implemented according to the pre-set information, stopping, by a controller, the discharge of the nano-patterning material.

In the performing of pre-heating, an end portion of a tip unit constituting the nano-patterning apparatus may be brought into contact with the region of the subject, and the region of the subject may be heated by heat according to a current flowing to the tip unit under the control of the controller.

In the discharging of the nano-patterning material, in a state in which the lip unit is heated, the nano-patterning material may be discharged through a flow channel form in the tip unit from a storage unit storing the nano-patterning material, and the nano-patterning material may include solder paste or conductive paste.

The stopping of the discharge of the nano-patterning material may include interrupting the current flowing to the tip unit to control the temperature of the tip unit such that it is lower than a melting temperature of the nano-patterning material, under the control of the controller.

The stopping of the discharge of the nano-patterning material may further include lifting the tip unit from the discharged nano-patterning material and performing nano-patterning on a different region.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view of a nano-patterning system including a nano-patterning apparatus according to an embodiment of the present invention;

FIG. 2A is a perspective view of a nano-patterning apparatus according to an embodiment of the present invention.

FIG. 2B is an exemplary view explaining an electrical connection state of a portion ‘A’ in FIG. 2A;

FIG. 3A is an exemplary view showing a tip unit of the nano-patterning apparatus according to an embodiment of the present invention;

FIG. 3B is an exemplary view showing a tip unit of the nano-patterning apparatus according to another embodiment of the present invention;

FIG. 4 is a flow chart illustrating a method of controlling a nano-patterning process according to another embodiment of the present invention; and

FIG. 5 is a view explaining sequential processes (a) through (d) of the method of controlling a nano-patterning process according to another embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

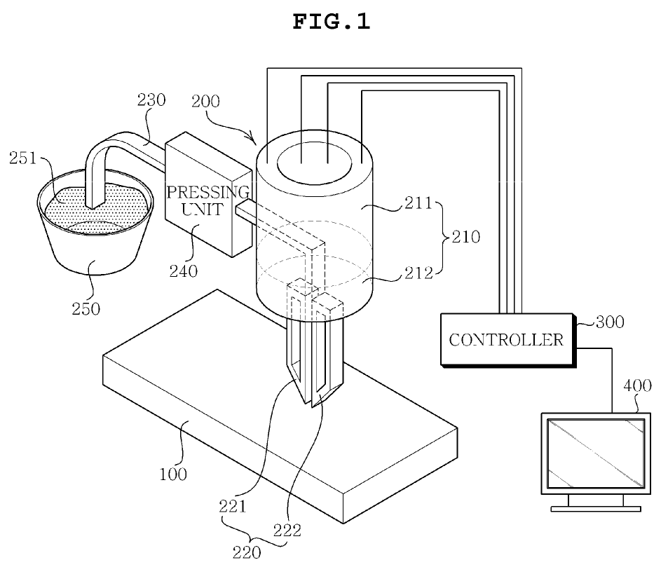

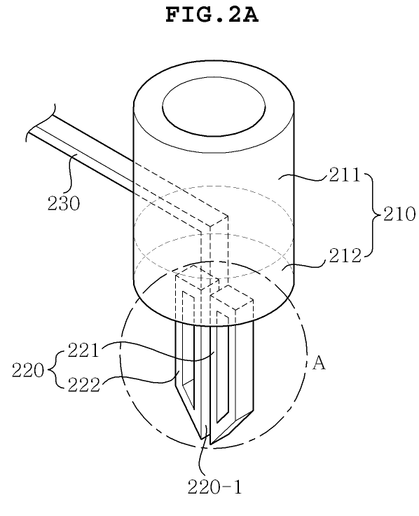

FIG. 1 is a schematic view of a nano-patterning system including a nano-patterning apparatus according to an embodiment of the present invention. FIG. 2A is a perspective view of a nano-patterning apparatus according to an embodiment of the present invention. FIG. 2B is an exemplary view explaining an electrical connection state of a portion ‘A’ in FIG. 2A. In the following description, the nano-patterning system according to an embodiment of the present invention patterns a printed circuit board, or the like, with a solder ball by using solder paste, but the present invention is not limited thereto and various other nano-patterns including a nano-level circuit pattern may be formed on the substrate, or the like, by using conductive paste.

As shown in FIG. 1, the nano-patterning system including a nano-patterning apparatus 200 according to an embodiment of the present invention includes a stage 100 allowing a subject, on which a pattern is to be formed through nano-patterning, to be mounted thereon, the nano-patterning apparatus 200 performing nano-patterning on the subject mounted on the stage 100, a controller 300 connected to the stage 100 and the nano-patterning apparatus 200 to control a nano-patterning process, and a display unit 400 connected to the controller 300 to display control information during the nano-patterning process.

The subject mounted on the stage 100 may include a printed circuit board (PCB) on which solder balls are to be formed through nano-patterning, a substrate on which a nano-level circuit pattern is to be formed through nano-patterning, and the like.

As shown in FIGS. 1 and 2A, the nano patterning apparatus 200 includes a holder unit 210 including a transfer unit 211 and an insulating unit 212, a tip unit 220 inserted into the holder unit 210, downwardly protruded, and including two tips 221 and 222 with a flow channel 220-1 interposed therebetween, a flow path 230 having one end connected to the flow channel 220-1 formed between the two tips 221 and 222 through one side (or a portion) of the insulating unit 212 and extending to the outside so as to serve as a movement path allowing a nano-patterning material to move (or flow) therealong, a pressing unit 240 pressing the nano-patterning material at one side of the flow path 230; and a storage unit 250 connected to the other end of the flow path 230 and storing the nano-patterning material 251 such as solder paste, conductive paste, or the like.

The holder unit 210 includes the transfer unit 211 connected to the controller 300 and the insulating unit 212 formed on a lower surface of the transfer unit 211 and made of an electrically insulating material.

In detail, the transfer unit 211 including a piezo-actuator or a motor is connected to the controller 300 and moving in an X-Y-Z axis. Preferably, a piezo-actuator, which can be finely or minutely controlled in a movement length thereof is used.

The insulating unit 212 is provided on the lower surface of the transfer unit 211 and supports the two tips 221 and 222 which are insertedly mounted therein and separated to form the flow channel 220-1 therebetween, and the flow path 230 is provided at one side of the insulating layer 212 and connected to the flow channel 220-1.

The tip unit 220 includes at least two tips, namely, the first tip 221 and the second tip 222, which are separated to form the flow channel 220-1 therebetween and is inserted into the insulting unit 212. As shown in FIG. 2B, the first tip 221 and the second tip 222 are formed to be hollow in a middle portion thereof, have a wedge shape gradually sharpened in a protruded direction, and are provided to be symmetrical with each other, having the same protrusion length.

Also, as shown in the circuit illustrated in FIG. 2B, the first tip 221 and the second tip 222 are connected to an external power source to form a single closed circuit, and a current flows to the first tip 221 and the second tip 222 along the closed circuit Here, an electric wire connected to the first tip 221 and the second tip 222 as shown in FIG. 2B may be provided to be connected through one side (or a portion) of the transfer unit 211 or one side of the insulating unit 212.

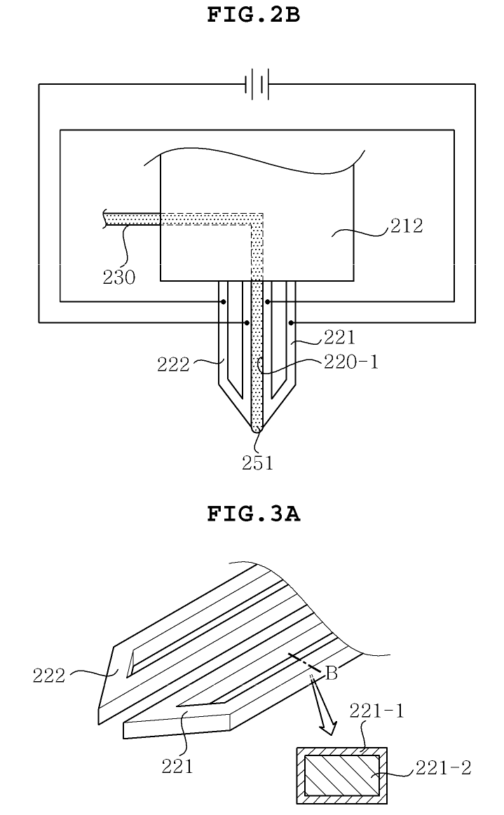

In this case, the first tip 221 and the second tip 222 may commonly include an insulator 221-2 formed therein and a high resistance metal film 221-1 covering the insulator 221-2 as can be seen from the section taken along line ‘B’ as shown in FIG. 3A. Here, the high resistance metal film 221-1 may be made of a metal material, e.g., tantalum, tungsten, or the like, having specific resistance higher than that of copper.

Thus, in the closed circuit illustrated in FIG. 2B, as a current flows along the high resistance metal film 221-1 of the first tip 221 and the second tip 222, heat is generated by the high resistance of the high resistance metal film 221-1 coated with a small thickness, increasing viscosity of the nano-patterning material 251 flowing along the flow channel 220-1.

Also, as shown in FIG. 3B, in another embodiment of the present invention, a tip unit may have a first tip 221′ and a second tip 222′ which have a different protrusion length.

The tip unit illustrated in FIG. 3B may be applied for nano-patterning to form a nano-level circuit pattern by using conductive paste. Namely, conductive paste discharged along the flow channel between the first tip 221′ and the second tip 222′, while being supported by the second tip 222′ at a rear side thereof, may also be provided along a circuit pattern path set on the substrate, to form a circuit pattern.

The controller 300 may be connected to the stage 100 and the nano-patterning apparatus 200 to generally control the nano-patterning process to adjust a discharged amount of nano patterning material 251 flowing along the flow channel 220-1 between the first tip 221 and the second tip 222 and adjust an amount of current flowing to the first tip 221 and the second tip 222 to thereby control a heating degree of the nano-patterning material 251 flowing along the flow channel 220-1.

In this case, in order to adjust the discharge amount of the nano-patterning material 251, the controller 300 may control the pressing unit 240 to adjust a pressure of discharging the nano-patterning material 251 flowing along the flow channel 220-1.

The nano-patterning system according to an embodiment of the present invention configured as described above includes the nano-patterning apparatus 200 which is able to continuously supply the nano-patterning material 251 stored in the storage unit 250 to the flow channel 220-1 of the tip unit 220 along the flow path 230.

Thus, since the nano-patterning system according to an embodiment of the present invention is able to continuously form a plurality of nano-patterns by using the nano-patterning apparatus 200, electronic components including the nano-patterns can be mass-produced.

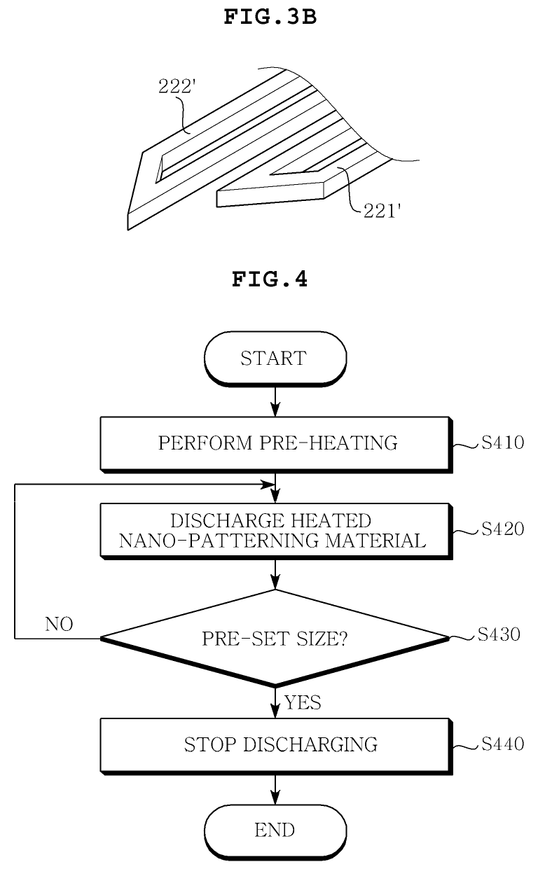

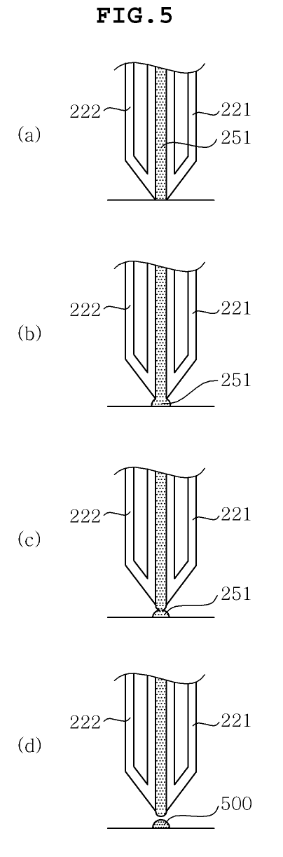

Hereinafter, a method of controlling a nano-patterning process according to another embodiment of the present invention will be described with reference to FIGS. 4 through 5(d). FIG. 4 is a flow chart illustrating a method of controlling a nano-patterning process according to another embodiment of the present invention, and FIG. 5 is a view explaining sequential processes (a) through (d) of the method of controlling a nano-patterning process according to another embodiment of the present invention.

In the method of controlling a nano-patterning process according to another embodiment of the present invention, first, a region of a subject (or a target) on which a nano-pattern is to be formed is pre-heated (S410).

For example, as shown in FIG. 5(a), the controller 300 brings an end portion of the tip unit 220 into contact with a region of the PCB on which a solder ball 500 is to be formed, and heats the contacted region of the PCB by heat according to a current flowing to the first tip 221 and the second tip 222. Through this pre-heating process, adhesive force between the region of the PCB, on which the solder ball 500 is to be formed, and the solder ball 500 can be enhanced.

After the pre-heating process is performed, the controller 300 discharges the nano-patterning material 251 to the region of the pre-heated subject through the flow channel 220-1 between the first tip 221 and the second tip 222 (S420).

Namely, as shown in FIG. 5(b), the controller 300 separates the tip unit 220 from the PCB, while heating the first tip 221 and the second tip 222 at a temperature higher than a melting temperature of the nano-patterning material 251, namely, a melting temperature of a solder paste, by heat according to the current flowing to the first tip 221 and the second tip 222.

In this case, the controller 300 may adjust a distance between the tip unit 220 and the PCB according to a pre-set size of the solder ball 500 to be formed.

After discharging the nano-patterning material 251, the controller 300 determines whether or not the discharged nano-patterning material 251 has been implemented to have the pre-set size (S430).

In this case, as shown in FIG. 5(c), the controller 300 may calculate an amount of discharged solder paste or may detect an area in which the solder paste has been discharged, a contact angle, or the like, by using an electron microscope device to determine whether or not the discharged nano-patterning material 251 has been implemented to have the pre-set size.

Thus, according to determination results in step S430 for determining whether or not the discharged nano-patterning material 251 has been implemented to have the pre-set size, the controller 300 may control the pressing unit 240 to adjust a discharge amount of the solder paste.

When the discharged nano-patterning material 251 has been implemented to have the pre-set size, the controller 300 stops discharging the nano-patterning material 251 and lifts up the tip unit 220 to perform nano-patterning on a different region (S440).

Namely, as shown in FIG. 5(d), the controller 300 controls the pressing unit 240 to stop discharging the solder paste through the flow channel 220-1 and interrupts the current flowing to the first tip 221 and the second tip 222 to drop the temperature of the first tip 221 and the second tip 222 to be lower than the melting temperature of the solder paste.

Thus, in a state in which the solder paste is stopped from being discharged, the controller 300 lifts the tip unit 220 and controls the transfer unit 211 of the holder unit 210 to transfer the nano-patterning apparatus 200 to a different region of the PCB on which nano-patterning is to be performed.

Through the method of controlling a nano-patterning process according to another embodiment of the present invention, which includes the foregoing processes, nano-patterns made of solder paste or conductive paste can be easily and continuously formed by using the nano-patterning apparatus 200.

Thus, through the method of controlling a nano-patterning process according to another embodiment of the present invention, a plurality of nano-patterns having a pre-set size can be formed and electronic components (or parts) including nano-patterns can be mass-produced.

According to the embodiments of the present invention, the nano-patterning system can continuously form a plurality of nano-patterns made of solder paste or conductive paste by using the nano-patterning apparatus, obtaining an effect that it can mass-produce electronic components including nano-patterns.

Also, through the nano-patterning control method, nano-patterns made of solder paste or conductive paste can be easily formed according to pre-set information by using the nano-patterning apparatus.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A nano-patterning apparatus comprising:
a holder unit including a transfer unit and an insulating unit;
a tip unit inserted into the holder unit, downwardly protruded, and having a flow channel;
a flow path having one end connected to the flow channel through one side of the transfer unit or the insulating unit and extending to the outside to serve as a movement path allowing a nano-patterning material to move therealong;
a pressing unit pressing the nano-patterning material at one side of the flow path; and
a storage unit connected to the other end of the flow path and storing the nano-patterning material.

2. The nano-patterning apparatus as set forth in claim 1, wherein the tip unit includes at least two tips, and the flow channel is formed between the two tips.

3. The nano-patterning apparatus as set forth in claim 2, wherein the tip is formed such that a middle portion thereof is hollow, and has a wedge shape gradually sharpened in a protruded direction.

4. The nano-patterning apparatus as set forth in claim 2, wherein the two tips have the same protrusion length and are provided to be symmetrical with each other.

5. The nano-patterning apparatus as set forth in claim 2, wherein the two tips are provided such that protrusion lengths thereof are different.

6. The nano-patterning apparatus as set forth in claim 2, wherein the tip includes an insulator formed therein and a high resistance metal film covering the insulator, and generates heat when a current is applied through the high resistance metal film.

7. The nano-patterning apparatus as set forth in claim 1, wherein the transfer unit includes a piezo-actuator or a motor.

8. The nano-patterning apparatus as set forth in claim 1, wherein the nano-patterning material includes solder paste or conductive paste.

9. A nano-patterning system comprising:
a stage allowing a subject, on which a pattern is to be formed through nano-patterning, to be mounted thereon;
a nano-patterning apparatus performing nano-patterning on the subject mounted on the stage;
a controller connected to the stage and the nano-patterning apparatus to control a nano-patterning process; and
a display unit connected to the controller to display control information during the nano-patterning process.

10. The nano-patterning system as set forth in claim 9, wherein the nano-patterning apparatus includes:
a holder unit including a transfer unit and an insulating unit;
a tip unit inserted into the holder unit, downwardly protruded, and having a flow channel;
a flow path having one end connected to the flow channel through one side of the transfer unit or the insulating unit and extending to the outside to serve as a movement path allowing a nano-patterning material to move therealong;
a pressing unit pressing the nano-patterning material at one side of the flow path; and
a storage unit connected to the other end of the flow path and storing the nano-patterning material.

11. The nano-patterning system as set forth in claim 10, wherein the tip unit includes at least two tips, and the flow channel is formed between the two tips.

12. The nano-patterning system as set forth in claim 10, wherein the tip is formed such that a middle portion thereof is hollow and has a wedge shape gradually sharpened in a protruded direction.

13. The nano-patterning system as set forth in claim 10, wherein the tip includes an insulator formed therein and a high resistance metal film covering the insulator, and generates heat when a current is applied to the high resistance metal film by the controller.

14. The nano-patterning system as set forth in claim 10, wherein the transfer unit includes a piezo-actuator or a motor and is connected to the controller so as to be position-controlled in X-Y-Z axes directions.

15. The nano-patterning system as set forth in claim 10, wherein the nano-patterning material includes solder paste or conductive paste.

16. A method of controlling nano-patterning, the method comprising:
performing pre-heating on a region of a subject, on which a nano-pattern is to be formed, by using a nano-patterning apparatus;
discharging a nano-patterning material to the region of the pre-heated subject by using the nano-patterning apparatus;
determining whether or not the nano-patterning material has been discharged to be implemented according to pre-set information; and
when the nano-patterning material has been implemented according to the pre-set information, stopping, by a controller, the discharge of the nano-patterning material.

17. The method as set forth in claim 16, wherein, in the performing of pre-heating, an end portion of a tip unit constituting the nano-patterning apparatus is brought into contact with the region of the subject, and the region of the subject is heated by heat according to a current flowing to the tip unit under the control of the controller.

18. The method as set forth in claim 17, wherein, in the discharging of the nano-patterning material, in a state in which the tip unit is heated, the nano-patterning material is discharged through a flow channel form in the tip unit from a storage unit storing the nano-patterning material, and the nano-patterning material includes solder paste or conductive paste.

19. The method as set forth in claim 17, wherein the stopping of the discharge of the nano-patterning material includes:
interrupting the current flowing to the tip unit to control the temperature of the tip unit such that it is lower than a melting temperature of the nano-patterning material, under the control of the controller.

20. The method as set forth in claim 17, wherein the stopping of the discharge of the nano-patterning material further includes:
lifting the tip unit from the discharged nano patterning material and performing nano-patterning on a different region.
